(19) United States
(12) Patent Application Publication
(10) Pub. No.: US 2025/0005917 A1
(43) Pub. Date: Jan. 2, 2025

(54) Method for Updating Artificial Intelligence Model Data for Smart Vending Machines

(71) Applicant: Beijing InHand Networks Technology Co., Ltd., Beijing (CN)

(72) Inventor: Liyin Zhang, Beijing (CN)

(21) Appl. No.: 18/756,979

(22) Filed: Jun. 27, 2024

(30) Foreign Application Priority Data
Jun. 30, 2023 (CN) 202310794913.4

(51) Int. Cl. G06V 10/82; G06V 10/764; G06V 10/774; G07F 9/00

(52) U.S. Cl. CPC G06V 10/82; G06V 10/764; G06V 10/7753; G07F 9/006

(57) ABSTRACT

The present invention discloses a method for updating artificial intelligence model data for smart vending machines, the method including: acquiring an actual purchase video including an untrained new product and determined by a product recognition algorithm or manual review, the actual purchase video being annotated with target product SKU information; intercepting new product sub-images from the actual purchase video; storing the product partial sub-images in a database of new product sub-images to be processed; initiating verification of all the product partial sub-images in the database of new product sub-images to be processed when the number of the product partial sub-images in the database of new product sub-images to be processed exceeds a given threshold; obtaining a new product replacement image by screening the product partial sub-images in the database of new product sub-images to be processed, and verifying the recognition accuracy of the screened new product replacement image; after the verification passes, introducing the screened new product replacement image into an original new product sample image gallery to replace the product sample image of the untrained product in the product recognition algorithm.

### CROSS REFERENCE TO RELATED APPLICATIONS

The disclosure is provided based on and claims priority to the Chinese Patent Application No. 202310794913.4, filed on Jun. 30, 2023, the entire contents of which are incorporated herein by reference.

### FIELD

The present invention relates to the technical field of smart vending machines, and in particular to a method for updating artificial intelligence model data for smart vending machines.

### BACKGROUND

With the continuous development of vending machine technology, currently, open-door vending cabinets have gradually become a kind of relatively common vending machine in the field of unmanned vending. In the field of vending machines, the purchase method in which consumers actively open the door to take products can further improve consumers' purchasing experience as compared with the old-fashioned method of selecting products by pressing buttons. In addition, open-door vending cabinets reduces the requirements for hardware complexity of vending machines and can realize arrangement of different types of products in the same vending cabinet.

Currently, an open-door vending cabinet generally identifies consumers' purchasing behavior by visual recognition during its operation, thereby determining the quantity and price of the items purchased by the consumers. Based on this information, consumption checkout and deduction are performed on a remote management platform. In the process of realizing the above-mentioned purchase checkout, accurate identification of the type and quantity of products actually taken by the purchaser is an essential technical procedure to achieve accurate checkout for the purchase process.

However, in actual operation, the operator of a smart vending machine often needs to add new products to the vending machine, and when needed, the operator generally provides sample images of the newly added products, and the product recognition algorithm side performs the update training of the algorithm model based on images of the newly added products, so that the algorithm can be updated to achieve accurate recognition of the state of the newly added products. However, for the algorithm side, continuous updating of the recognition algorithm resulting from frequent product updating dramatically increases the training time of the algorithm model, which causes the update speed of the algorithm model to be far behind the supply speed of new products, resulting in a bad user experience for consumers in the operation of smart vending.

Accordingly, in response to the demand for upgrading the updating of the product recognition algorithm in the supply of new products, a novel data updating method is needed in the prior art to achieve rapid updating and deployment of the product recognition algorithm.

### SUMMARY

A technical problem to be solved by the present invention is to rapidly update and deploy a product recognition algorithm model for new products after product updating of the smart vending machine, so that the product recognition algorithm can rapidly and accurately recognize the new products.

A technical object to be achieved by the present invention is to provide a method for training unidentified products applicable to smart vending machines, the method including steps of:
acquiring an actual purchase video including an untrained new product and determined by a product recognition algorithm or manual review; the product recognition algorithm recognizing the SKU of the product in the actual purchase video based on product standard images that have undergone supervised learning and new product sample images that have not undergone supervised learning; the actual purchase video being annotated with target product SKU information;
intercepting new product sub-images from the actual purchase video; and storing the product partial sub-images in a database of new product sub-images to be processed;
initiating verification of all the product partial sub-images in the database of new product sub-images to be processed when the number of the product partial sub-images in the database of new product sub-images to be processed exceeds a given threshold; and
obtaining a new product replacement image by screening the product partial sub-images in the database of new product sub-images to be processed, and verifying the recognition accuracy of the screened new product replacement image; after the verification passes, introducing the screened new product replacement image into an original new product sample image gallery to replace the product sample image of the untrained product in the product recognition algorithm.

In one embodiment, the actual purchase video including an untrained new product and determined by a product recognition algorithm or manual review means that the product recognized by the product recognition algorithm in the actual purchase video is un untrained new product; or that a new product whose recognition result output by the product recognition algorithm has a low confidence level and thus subjected to manual review, and the recognition result by manual review is determined to be an untrained new product.

In one embodiment, the intercepting new product sub-images from the actual purchase video includes:
detecting a product partial area on each frame image of the actual purchase video using a target detection model;
performing binary classification on all the product partial areas and deleting non-product partial areas;
intercepting images of the remaining product partial areas to generate the product partial sub-images;
generating a feature matrix of the product partial sub-images based on the product partial sub-images; and generating a feature matrix of all product images based on all the product images, the all product images including the product standard images and the new product sample images;
performing REID classification on the feature matrix of the product partial sub-images and the feature matrix of all product images to obtain the product SKU classification result of each of the product partial sub-images; and
determining the new product sub-image to be finally intercepted based on the classification result.

In one embodiment, the determining the new product sub-image to be finally intercepted based on the classification result includes: based on the SKU information corresponding to each product partial sub-image and indicated in the classification result, screening for the SKU information that is the same as the target SKU information, and retaining the product partial sub-image that has a REID classification confidence value exceeding a given threshold based on the REID classification confidence values of all product partial sub-images.

In one embodiment, the obtaining a new product replacement image includes:
calculating the feature matrix of all product partial sub-images in the database of new product sub-images to be processed;
calculating a cosine distance between each row of the feature matrix of all product partial sub-images and all other rows thereof; and deleting images whose cosine distance is greater than a first cosine distance threshold τ₁;
screening, among the remaining product partial sub-images, for the product partial sub-image whose cosine distance is greater than a second cosine distance threshold τ₂ as the new product replacement image, and using the remaining images as new product reference images.

In one embodiment, the verifying the recognition accuracy of the screened new product replacement image includes: performing REID classification on the new product reference images using the new product replacement image as a reference to obtain a first accuracy; performing REID classification on the new product reference images using the new product sample image as a reference to obtain a second accuracy; and the verification passing when the first accuracy is greater than the second accuracy.

In comparison with the prior art, one or more embodiments of the present invention may have the following advantages.

In the present invention, data processing is performed on the actual purchase video of the untrained product created in the actual operation process of a smart vending machine, thereby enabling rapid replacement of new product sample images that is used in the product recognition model and have not undergone supervised learning. Thus, the product recognition model can be rapidly applied for the accurate recognition of new products. Consequently, this reduces the workload required for updating of the artificial intelligence algorithm after supply of new products in the smart vending machine.

Other features and advantages of the present invention will be described in the following description, and partly become apparent from the description, or appreciated by implementation of the present invention. The object and other advantages of the present invention can be realized and achieved by the structures particularly indicated in the description, claims, and accompanying drawings.

### BRIEF DESCRIPTION OF THE DRAWINGS

The accompanying drawings are used to provide a further understanding of the present invention and constitute a part of the specification. They are used to illustrate the present invention along with the examples of the present invention and are not a limitation of the present invention. In the drawings:

FIG. 1 is a flow chart of a method for updating artificial intelligence model data for smart vending machines according to a first example of the present invention;

FIG. 2 is a flow chart of a procedure of intercepting a new product sub-image from an actual purchase video according to the first example of the present invention;

FIG. 3 is a flow chart of a verification process in the first example of the present invention;

FIG. 4 is a block diagram of the structure of an electronic device according to a second example of the present invention; and

FIG. 5 is a schematic structural diagram of a computer system for the method for updating artificial intelligence model data according to a second example of the present invention.

### DETAILED DESCRIPTION

The present invention may be a system, method, and/or computer program product at any possible level of integrated technical detail. The computer program product may include one or a plurality of computer-readable storage media having a computer-readable program instruction stored therein for causing a processor to implement various aspects of the present invention.

The computer-readable storage medium may be a tangible device that can retain and store instructions used by a device for instruction execution. The computer-readable storage medium may be, but not limited to, for example, an electronic storage device, a magnetic storage device, an optical storage device, an electromagnetic storage device, a semiconductor storage device, or any suitable combination thereof. A non-exhaustive list of more specific examples of the computer-readable storage medium includes: a portable computer floppy disk, a hard disk, a random access memory (RAM), a read-only memory (ROM), an erasable programmable read-only memory (EPROM or flash memory), a static random access memory (SRAM), a portable compact disk read-only memory (CD-ROM), a digital versatile disk (DVD), a memory stick, a floppy disk, a mechanical encoder such as a punched card or a raised structure with instructions recorded therein in a groove, and any suitable combination thereof. A computer-readable storage medium, as used herein, should not be interpreted as a transient signal itself, such as a radio wave or other freely propagating electromagnetic wave, an electromagnetic wave propagating through a waveguide or other transmission medium (e.g., a light pulse through a fiber-optic cable), or an electrical signal transmitted through a wire.

The computer-readable program instruction described herein may be downloaded from the computer-readable storage medium to a corresponding computing/processing device, or downloaded to an external computer or external storage device via a network, such as the Internet, a local area network, a wide area network, and/or a wireless network. The network may include a copper transmission cable, an optical transmission fiber, wireless transmission, a router, a firewall, a switch, a gateway computer, and/or an edge server. A network adapter card or network interface in each computing/processing device receives the computer-readable program instruction from the network and forwards the computer-readable program instruction to store it in the computer-readable storage medium in the corresponding computing/processing device.

The computer-readable program instruction for performing the operation of the present invention may be an assembler instruction, an instruction set architecture (ISA) instruction, a machine instruction, a machine-dependent instruction, microcode, a firmware instruction, state setting data, configuration data for an integrated circuit, or source code or object code written in any combination of one or more programming languages and a procedural programming language. The computer-readable program instruction may be executed entirely on the user's computer, partially on the user's computer, partially on the user's computer as an independent software package, partially on a remote computer, or entirely on a remote computer or a server. In the case of the remote computer, the remote computer may be connected to the user's computer via any type of network, including a local area network (LAN) or a wide area network (WAN), or a connection to an external computer may be made (e.g., via the Internet provided by an Internet service provider). In some examples, the computer-readable program instruction can be executed by an electronic circuit including, for example, a programmable logic circuit, a field programmable gate array (FPGA), or a programmable logic array (PLA) using the state information of the computer-readable program instruction, which enables personalization of the electronic circuit, thereby implementing various aspects of the present invention.

Various aspects of the present invention are described herein with reference to the flow charts and/or block diagrams of the method, device (system), and computer program product according to the examples of the present invention. It can be understood that each block of the flow chart illustration and/or block diagrams and combinations of blocks in the flow chart illustration and/or block diagrams can be implemented by the computer-readable program instructions.

These computer-readable program instructions may be provided to a processor of a computer or other programmable data processing device to produce a machine such that the instructions executed by the processor of the computer or other programmable data processing device create a means for implementing the functions/actions specified in one or more blocks of the flow charts and/or block diagrams. These computer-readable program instructions may also be stored in a computer-readable storage medium capable of booting a computer, a programmable data processing device, and/or another device that operates in a particular manner, so that the computer-readable storage medium having the instructions stored therein includes a manufactured product including instructions for implementing the aspects of the functions/actions specified in the blocks of the flow charts and/or block diagrams.

The computer readable program instructions may also be loaded into a computer, another programmable data processing device, or another device to cause a series of operating steps to be performed in the computer, and the other programmable device or other device for producing a computer-implemented process causes the instructions executed in the computer, other programmable device, or other device to implement the functions/actions specified in the blocks of the flow charts and/or block diagrams.

The flow charts and block diagrams in the drawings illustrate achievable system architectures, functions, and operations of the system, method, and computer program product according to various examples of the present invention. In this regard, each block in the flow charts or block diagrams may represent a module, segment, or portion of the instructions, which includes one or more executable instructions for implementing the specified logical function. In some optional embodiments, the functions indicated in the blocks may be operated out of the order indicated in the drawings. For example, in practice, two blocks shown in succession may be completed as a step, or executed in a concurrent or substantially concurrent manner with part or all of the time overlapping, or these blocks may sometimes be implemented in a reverse order, depending on the functions involved. It is also noted that each block of the block diagrams and/or flow chart illustration, and combinations of blocks in the block diagrams and/or flow chart illustration, may be implemented by a dedicated hardware-based system that executes the specified functions or actions or executes a combination of dedicated hardware and computer instructions.

### Example 1

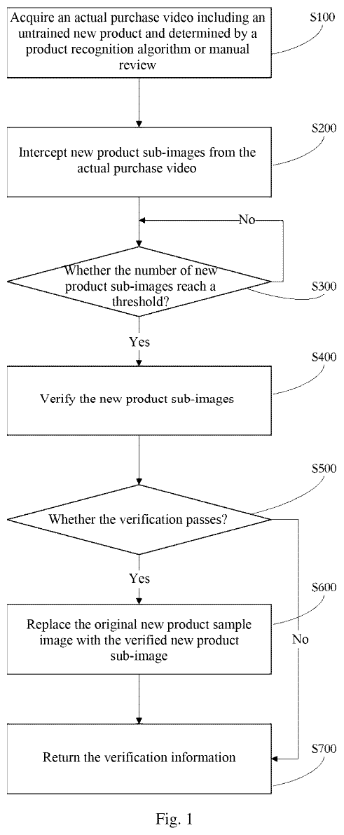

As shown in FIG. 1, the method for updating artificial intelligence model data for smart vending machines according to the present example includes the following steps.

In Step S100, an actual purchase video including an untrained new product and determined by a product recognition model or manual review is acquired. The actual purchase video of the untrained new product is created during the actual operation of a smart vending machine. During the actual operation of the smart vending machine, when the untrained new product is updated to the smart vending machine, the operator of the smart vending machine provides a sample image of the untrained new product to the algorithm side of the product recognition checkout of the smart vending machine for updating and training of the product recognition model by the algorithm side. Therefore, after the algorithm side acquires the sample image of the untrained new product, the entire product image database of the product recognition algorithm model includes two categories of images. Namely, one category is the product standard images (trained_gallery) (i.e., the product standard image gallery) that has completed the supervised learning of the algorithm model, and all of which correspond to a clear and unique product SKU information; and the other category is the new product sample images (extra_gallery) (i.e., the new product sample image gallery) that are provided by the operator and has not undergone supervised learning of the algorithm model, but each of which corresponds to a clear and unique product SKU information (i.e., the product SKU specified by the operator).

It is an object of the present example to update the image data of the new product sample image gallery by the data updating method of the present invention to make it consistent with the images in the product standard image gallery. Specifically, the new product sample images are not the images including actual selling behavior and generated in the actual operation of the smart vending machine, and are generally images obtained through directly capturing the new product by the operator. The image structure and product angle of the new product sample image are inconsistent with the images in the video created when the actual purchase behavior occurs on the smart vending machine. This greatly reduces the recognition accuracy of the subsequent product recognition using a REID model, for example. Therefore, the recognition accuracy of the product recognition algorithm can be effectively improved by replacement of the new product sample images.

In the process of acquiring an actual purchase video including an untrained new product and determined by a product recognition model or manual review, there are two main ways to generate the actual purchase video of the untrained new product. The first way is to use the product recognized by the product recognition algorithm in the actual purchase video as an untrained new product SKU, that is, this recognition result is obtained by the product recognition algorithm based on the above-mentioned new product sample image gallery. The second way is to subject the recognition result output by the product recognition algorithm and having a low confidence level to manual review, providing a result that the product is determined to be an untrained new product. The actual purchase video of the untrained new product obtained by the two ways described above is used as original data for the image data updating method of the present invention. It should be noted here that all the actual purchase videos are annotated with determined target SKU information. That is, the actual purchase video, whether recognized by the product recognition model or manually marked by manual review, is annotated with data including the product SKU information corresponding to the video, that is, the target SKU information.

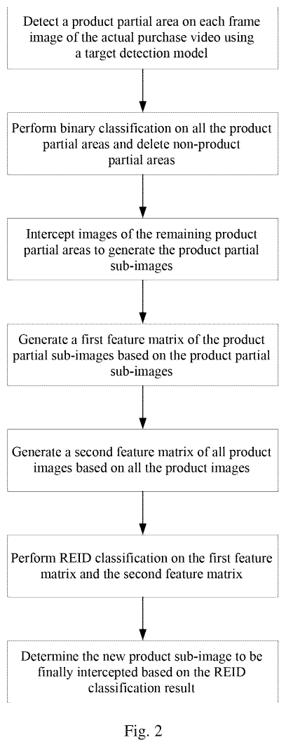

In Step S200, new product sub-images are intercepted from the actual purchase video. The procedure of the intercepting new product sub-images from the actual purchase video is shown in FIG. 2.

First, a product partial area on each frame image of the actual purchase video is detected using a target detection model. The product partial area can be detected using the target detection algorithm based on yolo series. Each frame image of the input actual purchase video of the untrained new product is detected using the target detection algorithm. If a purchased product is present in a frame image, the target detection algorithm outputs the rectangular frame bbox of the purchased product. bbox=[(x₁, y₁), (x₂, y₂)], where (x₁, y₁) and (x₂, y₂) correspond to the upper left corner and lower right corner coordinates of the rectangular frame of the purchased product in the current frame image, respectively. It is noted that when a plurality of products are present in a frame image, the target detection model acquires a plurality of rectangular frames bbox.

Subsequently, binary classification is performed on all the partial areas of the product, and non-product partial areas are deleted. It is distinguished whether the currently detected product partial area is a non-product image using the binary classification detection model according to binary classification categories and a pre-set screening threshold. The binary classification model used may be VGG, ResNeXt, or DenseNet. If the frame image is a non-product image, the product partial area information is discarded. The confidence level output by the binary classification detection model refers to the possibility that the current image includes a product. Only when the confidence level exceeds the pre-set threshold, it is considered that the product partial area currently detected includes a product for sale.

Then, images of all product partial areas are intercepted to generate the product partial sub-images. That is, images of the product partial areas remaining after the binary classification screening of the product partial areas are intercepted to generate a plurality of product partial sub-images dtc_{imgs}.

Then, a first feature matrix (query_feature) of the product partial sub-images is generated based on the product partial sub-images. That is, the first feature matrix B^{p×n} corresponding to the current product partial sub-images is calculated using the reid model. It is noted that p is the number of partial sub-images obtained after the detection, and n is the dimension size set in advance in the supervised learning of the product recognition algorithm. Each row of the first feature matrix corresponds to a feature matrix of one product partial sub-image.

Subsequently, a second feature matrix (gallery_feature) of all product images is generated based on all the product images, the all product images including all images in a product standard image gallery and a new product sample image gallery, namely, including both product standard images and new product sample images.

Calculation is performed on all the product images included in the current order using the reid model to obtain the second feature matrix A^{m×n}, where m is the number of images of all the SKUs sold by the current smart vending machine, and n is the dimension size set in advance in the supervised learning of the algorithm. Each row of the matrix corresponds to the characteristic value of a SKU.

$$For example : gallery = \text{} [ [ {path}_{{1}_{1}} \underbrace{, … ,}_{{sku}_{1}} {path}_{{1}_{n}} ] , … , [ {path}_{{m}_{1}} \underbrace{, … ,}_{{sku}_{m}} {path}_{{m}_{j}} ] ] ,$$

where m is the number of all images in the gallery, and path; represents the image address of the i-th product. That is, one SKU has a plurality of product images.

Next, REID classification is performed based on the first feature matrix and the second feature matrix. Specifically, the cosine distance between each row of the first feature matrix and the second feature matrix is calculated to obtain a cosine distance matrix C^{p×m}. The minimum coordinates (i, j) of each column of the cosine distance matrix C^{p×m} are obtained, where i is the image index of the current product standard image, and j is the image index of the product partial sub-image. Since each product standard image has corresponding SKU information, the product SKU classification result of each image in the product partial sub-images is obtained.

Then, the new product sub-image to be finally intercepted is determined based on the REID classification result. This step includes, based on the SKU information corresponding to each product partial sub-image and indicated in the REID classification result, screening for the SKU information that is the same as the target SKU information, and retaining the product partial sub-images that has a REID classification confidence value exceeding a given threshold based on the REID classification confidence values of all product partial sub-images.

Finally, the retained product partial sub-images are stored in a database of new product sub-images to be processed;

In Step S300, verification of all the product partial sub-images in the database of new product sub-images to be processed is initiated when the number of the product partial sub-images in the database of new product sub-images to be processed exceeds a given threshold. Otherwise, the accumulation of product partial sub-images continues. In the present example, the threshold of the number of the images can be set to 200.

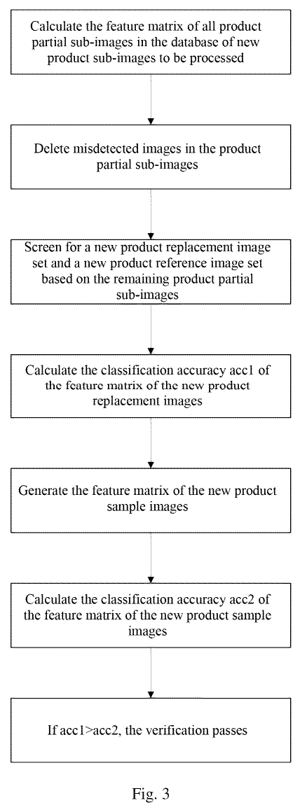

In Step S400, product partial sub-images in the database of new product sub-images to be processed are verified. The verification process is shown in FIG. 3 and includes the following steps.

The feature matrix of all product partial sub-images in the database of new product sub-images to be processed is calculated. The feature matrix D^{d}^{₁}^{×n} of all product partial sub-images is obtained using the reid model, where d₁ is the number of product partial sub-images currently to be verified.

Subsequently, misdetected images in the product partial sub-images are deleted. Namely, the cosine distance value of each row of the feature matrix D^{d}^{₁}^{×n} and all other rows thereof is calculated, that is, the similarity between the current image and all other images is calculated. Images with a cosine distance greater than a first cosine distance threshold τ₁ are identified as images with a large feature difference and then deleted. In the present example, the first cosine distance threshold τ₁ is set to τ₁=0.9.

Subsequently, the images with a cosine distance value greater than a second cosine distance threshold 12 among of the cosine distance values of the retained images are screened as new product replacement images (gallery images), and the rest are new product reference images (query images). At the same time, the feature matrix D^{d}^{₂}^{×n} of the new product replacement images and the feature matrix D^{d}^{₃}^{×n} of the new product reference images are calculated.

Then, the feature matrices of all categories obtained using the current reid model that have undergone supervised learning and the feature matrices D^{d}^{₂}^{×n} of the new product replacement images are merged to obtain a third feature matrix D^{d}^{₄}^{×n} for reid classification.

the cosine distance D_{cos}^{d}^{₄}^{×d}^{₃} between each row of the third feature matrix D^{d}^{₄}^{×n} and the feature matrix D^{d}^{₃}^{×n} of the new product reference images is calculated to obtain the minimum coordinates (ij) of each column of D_{cos}^{d}^{₄}^{×d}^{₃}, where i is the image index of the current new product replacement image, and j is the image index of the new product reference image. Since each new product replacement image has a corresponding SKU, the classification result of each image in the new product reference images is obtained.

The accuracy acc1 of the classification result using the new product replacement images as a reference is calculated. The equation for accuracy calculation is as follows: acc=number of accurately classified images/number of images to be recognized, where the number of accurately classified images refers to the number of the current new product reference images whose classification result is target SKUs to be verified.

Using the new product sample images, the feature matrix of F^{p×n} the new product sample images is calculated, where p is the number of the new product sample images. The cosine distance D_{cos}^{p×d}^{₃} between each row of the feature matrix F^{p×n} of the new product sample images and the cos feature matrix D^{d}^{₃}^{×n} of the new product reference images is calculated to obtain the minimum coordinates (ij) of each column of D_{cos}^{p×d}^{₃}, where i is the image index of the current new product replacement image, and j is the image index of the new product reference image. Since each new product replacement image has a corresponding SKU, the classification result of each image in the new product reference images is obtained.

The accuracy acc2 of the classification result using the new product sample images as a reference is calculated.

When the accuracy acc1 is greater than the accuracy acc2, the verification is deemed to pass. When the accuracy acc1 is less than the accuracy acc2, the verification fails.

In Step S500 and Step S600, when the verification passes, the above-screened new product replacement images are introduced into the original new product sample image gallery to replace the original product sample images.

In Step S700, when the verification fails, the verification information is returned, and the verification is performed again after updating of the product partial sub-images in the database of new product sub-images to be processed.

### Example 2

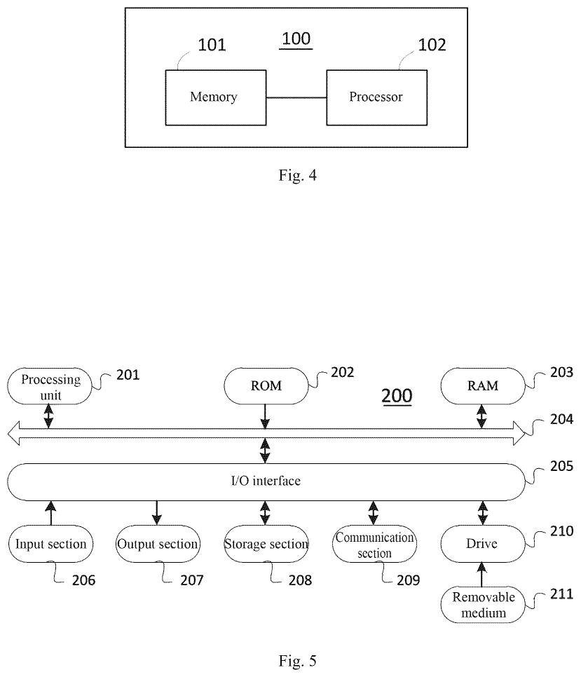

Further, the present example discloses an electronic device. FIG. 4 shows a block diagram of the structure of an electronic device according to an embodiment of the present disclosure. As shown in FIG. 4, the electronic device 100 includes a memory 101 and a processor 102; and specifically, the memory 101 is used to store one or more computer instructions, in which the one or more computer instructions are executed by the processor 102 to implement the above steps of the method.

FIG. 5 is a schematic structural diagram of a computer system for the method for updating artificial intelligence model data according to an embodiment of the present disclosure.

As shown in FIG. 5, the computer system 200 includes a processing unit 201, which can implement various processes in the above-described embodiment according to a program stored in a read-only memory (ROM) 202 or a program loaded from a storage section 208 to a random access memory (RAM) 203. The RAM 203 further stores various programs and data required for the operation of the system 200. The processing unit 201, the ROM 202, and the RAM 203 are connected to each other via a bus 204. An input/output (I/O) interface 205 is further connected to the bus 204.

To the I/O interface 205, connected are the following components: an input section 206 including a keyboard, a mouse, or the like; an output section 207 including a cathode ray tube (CRT), a liquid crystal display (LCD), a speaker, or the like; a storage section 208 including a hard disk or the like; and a communication section 209 including a network interface card such as a LAN card or a modem. The communication section 209 implements communication processing via a network such as the Internet. A drive 210 is further connected to the I/O interface 205 as needed. A removable medium 211, such as a magnetic disk, an optical disk, a magneto-optical disk, or a semiconductor memory, is amounted in the drive 210 as needed, so that a computer program read therefrom is installed in the storage section 208 as needed. Further, the processing unit 201 can be embodied as a processing unit such as a CPU, a GPU, a TPU, an FPGA, or an NPU.

In particular, according to an embodiment of the present disclosure, the method described above can be embodied as a computer software program. For example, an embodiment of the present disclosure includes a computer program product including a computer program tangibly included in a readable medium thereof, The computer program includes a program code for executing the data inspection method. In such an embodiment, the computer program can be downloaded from a network via the communication section 209 and installed, and/or installed from the removable medium 211.

The example of the present disclosure further discloses a computer program product including a computer program/instruction that, when executed by a processor, implements any of steps of the method described above.

The flow charts and block diagrams in the drawings illustrate achievable system architectures, functions, and operations of the system, method, and computer program product according to various embodiments of the present disclosure. In this regard, each block in the flow charts or block diagrams may represent a module, a program segment, or part of the code, which includes one or more executable instructions for implementing the specified logical function. Furthermore, it is noted that, in some optional implementations, the functions indicated in the blocks may be operated out of the order indicated in the drawings. For example, in practice, two blocks shown in succession may be implemented in a substantially concurrent manner, or may sometimes be implemented in a reverse order, depending on the functions involved. Furthermore, it is noted that each block in the block diagrams and/or flow charts, and combinations of blocks in the block diagrams and/or flow charts, may be implemented by a dedicated hardware-based system that executes the specified functions or actions or by a combination of dedicated hardware and computer instructions.

The units or modules involved in the embodiments described in the present disclosure may be realized in a manner of software or a hardware. The units or modules described may also be arranged in a processor. The names of these units or modules are not a limitation on the units or modules themselves in some cases.

In another aspect, the example of the present disclosure further provides a computer-readable storage medium, which may be a computer-readable storage medium included in the devices described in the embodiment described above or a computer-readable storage medium that exists independently and is not assembled into the devices. The computer-readable storage medium stores one or more programs which are used by one or more processors to implement the method described in the example of the present disclosure.

The above description is merely intended to illustrate preferred examples of the present disclosure and the technical principles used therein. Those skilled in the art should understand that the scope of the invention involved in the examples of the present disclosure is not limited to technical solutions configured of a specific combination of the above technical features, but should also encompass other technical solutions configured of any combination of the above technical features and equivalent features thereof without departing from the concept of the invention, for example, a technical solution configured by replacing the above feature with the technical feature with a similar function disclosed in the examples of the present disclosure (but which is not limited thereto).

What is claimed is:

1. A method for updating artificial intelligence model data for smart vending machines, the method comprising steps of:
acquiring an actual purchase video including an untrained new product and determined by a product recognition algorithm or manual review; the product recognition algorithm recognizing the SKU of the product in the actual purchase video based on product standard images that have undergone supervised learning and new product sample images that have not undergone supervised learning; the actual purchase video being annotated with target product SKU information;
intercepting new product sub-images from the actual purchase video; and storing the product partial sub-images in a database of new product sub-images to be processed;
initiating verification of all the product partial sub-images in the database of new product sub-images to be processed when the number of the product partial sub-images in the database of new product sub-images to be processed exceeds a given threshold; and
obtaining a new product replacement image by screening the product partial sub-images in the database of new product sub-images to be processed, and verifying the recognition accuracy of the screened new product replacement image; after the verification passes, introducing the screened new product replacement image into an original new product sample image gallery to replace the product sample image of the untrained product in the product recognition algorithm.

2. The method for updating artificial intelligence model according to claim 1, wherein the actual purchase video including an untrained new product and determined by a product recognition algorithm or manual review means that the product recognized by the product recognition algorithm in the actual purchase video is an untrained new product; or that a new product whose recognition result output by the product recognition algorithm has a low confidence level and thus subjected to manual review, and the recognition result by manual review is determined to be an untrained new product.

3. The method for updating artificial intelligence model according to claim 1, wherein the intercepting new product sub-images from the actual purchase video comprises:
detecting a product partial area on each frame image of the actual purchase video using a target detection model;
performing binary classification on all the product partial areas and deleting non-product partial areas;
intercepting images of the remaining product partial areas to generate the product partial sub-images;
generating a feature matrix of the product partial sub-images based on the product partial sub-images; and generating a feature matrix of all product images based on all the product images, the all product images including the product standard images and the new product sample images;
performing REID classification on the feature matrix of the product partial sub-images and the feature matrix of all product images to obtain the product SKU classification result of each of the product partial sub-images; and
determining the new product sub-image to be finally intercepted based on the classification result.

4. The method for updating artificial intelligence model according to claim 1, wherein the determining the new product sub-image to be finally intercepted based on the classification result comprises: based on the SKU information corresponding to each product partial sub-image and indicated in the classification result, screening for the SKU information that is the same as the target SKU information, and retaining the product partial sub-image that has a REID classification confidence value exceeding a given threshold based on the REID classification confidence values of all product partial sub-images.

5. The method for updating artificial intelligence model according to claim 1, wherein the obtaining a new product replacement image comprises:
calculating the feature matrix of all product partial sub-images in the database of new product sub-images to be processed;
calculating a cosine distance between each row of the feature matrix of all product partial sub-images and all other rows thereof; and deleting images whose cosine distance is greater than a first cosine distance threshold τ₁;
screening, among the remaining product partial sub-images, for the product partial sub-image whose cosine distance is greater than a second cosine distance threshold τ₂ as the new product replacement image, and using the remaining images as new product reference images.

6. The method for updating artificial intelligence model according to claim 1, wherein the verifying the recognition accuracy of the screened new product replacement image comprises: performing REID classification on the new product reference images using the new product replacement image as a reference to obtain a first accuracy; performing REID classification on the new product reference images using the new product sample image as a reference to obtain a second accuracy; and the verification passing when the first accuracy is greater than the second accuracy.

7. An electronic device comprising a memory and a processor; wherein:
the memory is used to store one or more computer instructions, wherein the one or more computer instructions are executed by the processor to implement the steps of the method according to any one of claims 1 to 6.

8. A computer-readable storage medium having a computer instruction stored therein, wherein the computer instruction, when executed by a processor, implements the steps of the method according to any one of claims 1 to 6.

9. A computer program product comprising a computer program/instruction, which, when executed by a processor, implements the steps of the method according to any one of claims 1 to 6.
